(19) United States
(12) Patent Application Publication
(10) Pub. No.: US 2019/0361406 A1
(43) Pub. Date: Nov. 28, 2019

(54) Speaking Alarm Clock

(71) Applicant: FAZLAN ABDULLAH, KUALA LUMPUR (MY)

(72) Inventor: FAZLAN ABDULLAH, KUALA LUMPUR (MY)

(21) Appl. No.: 16/422,938

(22) Filed: May 24, 2019

Related U.S. Application Data
(60) Provisional application No. 62/676,989, filed on May 27, 2018.

(51) Int. Cl. G04G 13/02

(52) U.S. Cl. CPC G04G 13/021

(57) ABSTRACT

The invention relates generally to an alarm system software which alerts the user by speaking the current time repetitively until the user turns off the alarm or a preset alarm duration is reached. Once the user wakes up from sleep by hearing the current time spoken repeatedly from the alarm clock system, the user will be aware of the current time without having to open the user's eyes to check the time by looking at a watch, clock or mobile phone.

### CLAIM OF BENEFIT TO PRIOR APPLICATION

This application claims the benefit of U.S. Provisional Application 62/676,989, entitled “Speaking Alarm Clock”, filed May 21, 2018.

### FIELD OF INVENTION

The present invention relates generally to alarm clock systems.

### BACKGROUND OF INVENTION

Regular alarm clocks including mobile phone alarm clock applications play music, annoying buzzers or other sounds to wake the user up when a preset alarm time occurs.

However, the user who is woken up by the alarm does not know whether he has woken up at the preset wake up time or has overslept until the user opens the user's eyes to check the time such as by looking at a watch, clock or the time displayed on a mobile phone.

There are currently mobile phone applications which speaks the current time but the spoken time announcement is spoken only once per minute interspersed with music or alarm tone. The user may not be able to realise what the actual time is as the user will be in a sleepy state. Hence this invention proposes an alarm system which speaks the time repeatedly so that the user will hear and be aware of the current time of the alarm, assisting the user to wake up.

### BRIEF SUMMARY OF THE INVENTION

The invention seeks to provide a solution by the alarm speaking the current time repeatedly until the user turns off the alarm or a preset alarm duration is reached. Once the user wakes up from sleep by hearing the repeated verbal spoken current time announcements from the alarm clock, the user will be aware of the current time without having to open the user's eyes to check the time by looking at a watch, clock or mobile phone.

### BRIEF DESCRIPTION OF DRAWINGS

FIG. 1 is an illustrative flowchart diagram of the present invention

### DETAILED DESCRIPTION OF THE INVENTION:

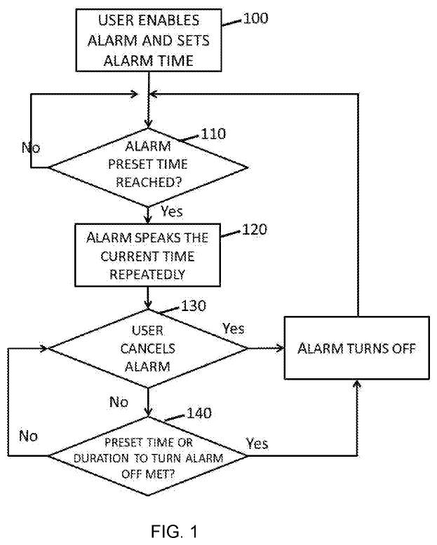

These and other features of this invention will be more readily understood from the following detailed description of the various aspects of the invention taken in conjunction with the accompanying drawings in which FIG. 1 depicts a logic flowchart according to one embodiment of the present invention.

The drawing is merely a schematic representation, not intended to portray specific parameters of the invention. The drawing is intended to depict only one typical embodiment of the invention, and therefore should not be considered as limiting the scope of the invention. In the drawings, like numbering represents like elements.

FIG. 1 is an illustrative flowchart diagram of the present invention. In the software application, the user sets the time 100 for the alarm to announce. Once the pre set alarm time has been reached 110 the alarm will start announcing the current time through the speaker of the handphone 120 until the user manually cancels the alarm 130 or the time has reached a predetermined duration or time 140 for the alarm to turn off.

In the preferred embodiment, this invention can be implemented as a mobile phone software application which has a text to speech voice synthesizer capability or prerecorded messages. The user uses the software speaking alarm application to select a preset time for the alarm to occur. The user also selects the duration the alarm will occur. At the preset alarm time, the alarm system will speak the current time repeatedly until stopped by the user or until a preset time or duration is reached whereupon the alarm is turned off. The repetitive verbal spoken current time announcements from the alarm clock will nag the user to wake up and stop the alarm, for example by the user touching a stop button on the alarm system application touchscreen. An example for the repetitive spoken time alarm is “Five thirty AM. Five thirty AM. Five thirty AM. Five thirty AM. Five thirty AM. Five thirty one AM. Five thirty one AM. Five thirty one AM.” and so on until the user stops the alarm. The alarm clock application may also include a snooze control, which will suspend the alarm function of the device for a predetermined time, at which time the verbal spoken time announcements will replay. This snooze function may be repeated any number of times or until a preset time or duration is reached whereupon the alarm is turned off.

In another embodiment, this invention can be implemented as a mobile phone software application which has a text to speech voice synthesizer capability. The user will use the software application to select a preset time for the alarm to occur. The user can optionally type or record phrases to be spoken before and/or after the current time is spoken to provide more information and motivation to the user to wake up. As an example the preset spoken message can be “The time is now (current time) wake up or you will be late for work! The time is now (current time) wake up or you will be late for work!”. The user can also preset a time interval between the spoken current time announcements instead of the current time being repeated continuously.

In another embodiment, the speaking alarm system can be implemented in a stand alone physical alarm clock which has a text to speech synthesizer capability or prerecorded voices. The user will use the alarm clock to select a preset time for the alarm to occur. The user will also select the preset duration the alarm will occur or until the alarm is stopped by the user, usually by pressing a button. The user can optionally type or record phrase to be spoken before and/or after the current time is spoken to provide more information and motivation to the user to wake up. As an example the preset spoken message can be “The time is now (current time) wake up or you will be late for work! The time is now (current time) wake up or you will be late for work!”. The user can also preset a time interval between the spoken current time announcements instead of the current time being repeated continuously. The alarm clock application may also include a snooze control, which will suspend the alarm function of the device for a predetermined time, at which time the verbal spoken time announcements will replay. This snooze function may be repeated any number of times or until the preset alarm duration is reached.

In another embodiment, the speaking alarm system can be implemented in a dormitory environment where an administrator can set a preset alarm time to wake a multitude of people sleeping in the dormitory by announcing the current time continuously through the public address system.

1. I claim the rights to any software or firmware or computer program for an alarm system characterized in that the alarm will repetitively speak the current time until stopped by the user.

2. An alarm system characterized in that the alarm will repetitively speak verbal message or messages before and after the repeating current time is spoken.

3. An alarm system characterized in that the alarm will repetitively speak verbal message or messages before the repeating current time is spoken.

4. An alarm system characterized in that the alarm will repetitively speak verbal message or messages after the repeating current time is spoken.
